(19) United States
(12) Patent Application Publication
(10) Pub. No.: US 2023/0324526 A1
(43) Pub. Date: Oct. 12, 2023

(54) METHOD FOR ACCURATE TIME-OF-FLIGHT CALCULATION ON THE COST-EFFECTIVE TOF LIDAR SYSTEM

(71) Applicant: Innovusion, Inc., Sunnyvale, CA (US)

(72) Inventors: Peng Wan, San Jose, CA (US); Yimin Li, Cupertino, CA (US); Junwei Bao, Los Altos, CA (US)

(73) Assignee: Innovusion, Inc., Sunnyvale, CA (US)

(21) Appl. No.: 18/126,053

(22) Filed: Mar. 24, 2023

Related U.S. Application Data
(60) Provisional application No. 63/323,999, filed on Mar. 25, 2022.

(51) Int. Cl. G01S 7/4865; G01S 7/487

(52) U.S. Cl. CPC G01S 7/4865; G01S 7/4873

(57) ABSTRACT

A method for calculating time-of-flight on a LiDAR system is provided. The method comprises transmitting outgoing light pulses to a beam steering system that redirects the outgoing light pulses to a field of view of the LiDAR system; detecting return pulses corresponding to the outgoing light pulses; obtaining an intensity of a return pulse of the detected return pulses; determining whether the intensity of the return pulse is within an intensity threshold; and based on the determination, selecting a pulse-center based method or a pulse-edge based method for measuring a time-of-flight between the return pulse and the corresponding outgoing light pulse. The time-of-flight is a time lapse between a timing of the return pulse and a timing of the corresponding outgoing light pulse. The method further comprises measuring the time-of-flight based on the selected method.

### CROSS-REFERENCE TO RELATED APPLICATIONS

This application claims priority to U.S. Provisional Pat. Application Serial No. 63/323,999, filed Mar. 25, 2022, entitled “A Method For Accurate Time-Of-Flight Calculation On The Cost-Effective TOF LiDAR System,” the content of which is hereby incorporated by reference in its entirety for all purposes.

### FIELD OF THE TECHNOLOGY

This disclosure relates generally to optical scanning and, more particularly, to time-of-flight (TOF) calculations for a cost-effective TOF-based LiDAR system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Embodiments described herein refer to LiDAR systems and methods for accurate time-of-flight calculation on a cost-effective TOF LiDAR system. A TOF LiDAR system scans the external environment and uses the time-of-flight technique to determine distance to objects in the external environment. Time-of-flight of a light pulse is measured from the time when an outgoing light pulse leaves the LiDAR system to the time when the return light pulse scattered by the objects returns to the LiDAR system. Distance to the objects can then be calculated by multiplying the time-of-flight and the speed of light. As the distance that light can travel in one nanosecond is approximately 0.3 meters, for a roundtrip travel time, a miscalculation of one nanosecond of time-of-flight can result in an error of approximately 0.15 meters in distance measurement. Therefore, the ability to accurately calculate time-of-flight plays an important role in the performance of a TOF LiDAR system.

A TOF LiDAR system uses signal detection circuitry to measure the time of the return light pulse. Return light pulse from an object may vary in width and intensity depending on the properties of the object, such as the object’s reflectance rate and distance, etc. For example, for objects with high reflectivity on the road such as license plates or windows, return light pulses from these objects tend to have high intensity and may cause the detection circuitry to saturate. When saturation occurs, significant errors may be introduced when the time of the return light pulse is measured, hence resulting in inaccurate time-of-flight calculation by the LiDAR system.

One way to avoid this problem is to use high performance sensors, analog-to-digital converters (ADCs), and signal detection circuitry to accommodate the high intensity signals so that saturation would not occur. However, this implementation may be costly. For example, an ADC with a high dynamic range may be cost-prohibitive for a TOF LiDAR system. Therefore, developing a cost-effective TOF LiDAR system with reasonable cost to accommodate the performance requirements is challenging. In this disclosure, cost-effective techniques for accurate time-of-flight measurement that can provide a balance between cost and performance of a TOF LiDAR system is disclosed.

In one embodiment, a LiDAR system for calculating time-of-flight is provided. The system includes a beam steering system, a light source, a detection system, and a controller. The light source is configured to emit outgoing light pulses that are steered by the beam steering system in accordance with a field of view of the LiDAR system. The detection system is configured to detect return pulses corresponding to the outgoing light pulses. The controller comprises one or more processors, a memory device, and processor-executable instructions stored in the memory device. The processor-executable instructions comprise instructions for: obtaining an intensity of a return pulse of the detected return pulses; determining whether the intensity of the return pulse is within an intensity threshold; and based on the determination, selecting a pulse-center based method or a pulse-edge based method for measuring a time-of-flight between the return pulse and the corresponding outgoing light pulse. The time-of-flight is a time lapse between a timing of the return pulse and a timing of the corresponding outgoing light pulse. The processor-executable instructions comprises further instructions for measuring the time-of-flight based on the selected method.

In another embodiment, a method for calculating time-of-flight on a LiDAR system is provided. The method comprises transmitting outgoing light pulses to a beam steering system that redirects the outgoing light pulses to a field of view of the LiDAR system; detecting return pulses corresponding to the outgoing light pulses; obtaining an intensity of a return pulse of the detected return pulses; determining whether the intensity of the return pulse is within an intensity threshold; and based on the determination, selecting a pulse-center based method or a pulse-edge based method for measuring a time-of-flight between the return pulse and the corresponding outgoing light pulse. Time-of-flight is a time lapse between a timing of the return pulse and a timing of the corresponding outgoing light pulse. The method further comprises measuring the time-of-flight based on the selected method.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an example arrangement of components in an optical receiver and light detector of a LiDAR system according to an embodiment.

FIG. 8 is a block diagram illustrating an example return pulse detection system according to an embodiment.

FIG. 9A illustrates an example return light pulse being sampled by an ADC when the ADC is not saturated, according to one embodiment.

FIG. 9B illustrates an example return light pulse being sampled by an ADC when the ADC is saturated at a maximum output value, according to one embodiment.

FIG. 10 illustrates using an exemplary pulse-center method to determine the timing of a return light pulse, according to one embodiment.

FIG. 11A illustrates using an exemplary edge-center method to determine the timing of a return light pulse when there are two sampled points on the rising edge according to an embodiment.

FIG. 11B illustrates another exemplary edge-center method used to determine the timing of a return light pulse when there are more than two sampled points on the rising edge according to an embodiment.

FIG. 12 is a flowchart illustrating an exemplary method for measuring the time-of-flight on a LiDAR system, according to an embodiment.

FIG. 13 illustrates an intensity to distance correction curve according to one embodiment.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Embodiments of present invention are described below. In various embodiments of the present invention, one embodiment of a LiDAR system for calculating time-of-flight includes a beam steering system, a light source, a detection system, and a controller. The light source is configured to emit outgoing light pulses that are steered by the beam steering system in accordance with a field of view of the LiDAR system. The detection system is configured to detect return pulses corresponding to the outgoing light pulses. The controller comprises one or more processors, a memory device, and processor-executable instructions stored in the memory device. The processor-executable instructions comprise instructions for: obtaining an intensity of a return pulse of the detected return pulses; determining whether the intensity of the return pulse is within an intensity threshold; and based on the determination, selecting a pulse-center based method or a pulse-edge based method for measuring a time-of-flight between the return pulse and the corresponding outgoing light pulse. The time-of-flight is a time lapse between a timing of the return pulse and a timing of the corresponding outgoing light pulse. The processor-executable instructions comprises further instructions for measuring the time-of-flight based on the selected method.

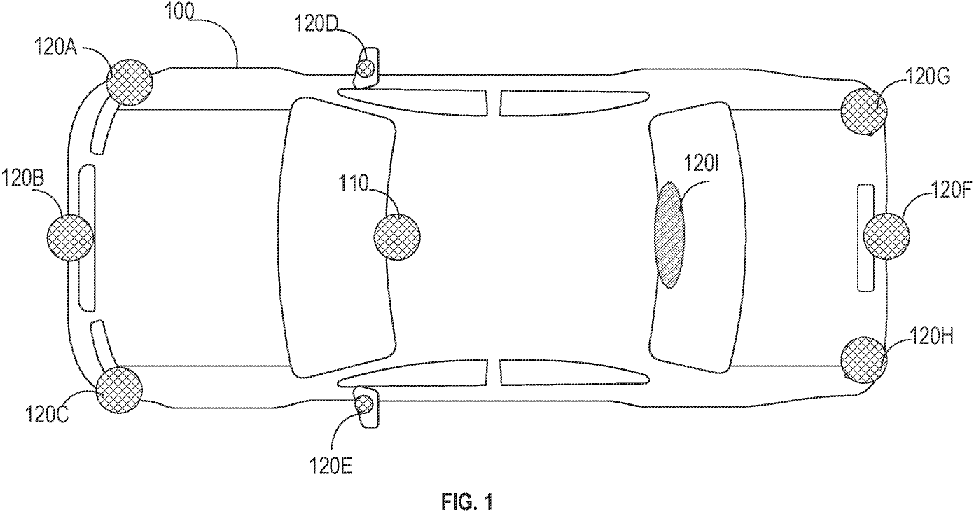

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver’s intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver’s intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner, LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

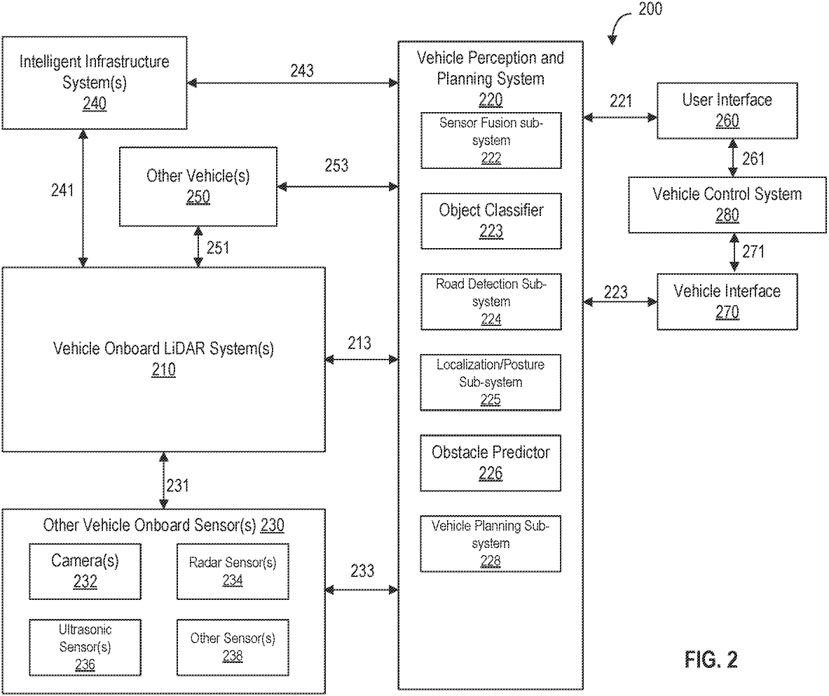

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle’s control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object’s position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle’s headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle’s posture. For example, using sensor data from LiDAR system(s) 210, camera(s) 232, and/or GPS data, localization and vehicle posture sub-system 225 can determine an accurate position of the vehicle on the road and the vehicle’s six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle’s location. For instance, using the HD maps, localization and vehicle posture sub-system 225 can determine precisely the vehicle’s current position (e.g., which lane of the road the vehicle is currently in, how close it is to a curb or a sidewalk) and predict vehicle’s future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle’s trajectory intersects with the vehicle’s current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle’s current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle’s steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle’s location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

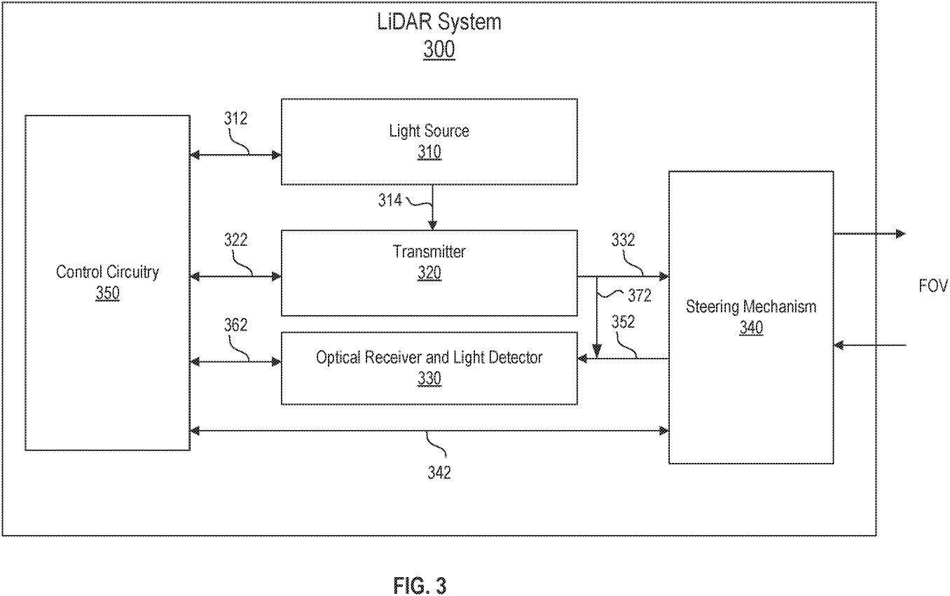

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object’s range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

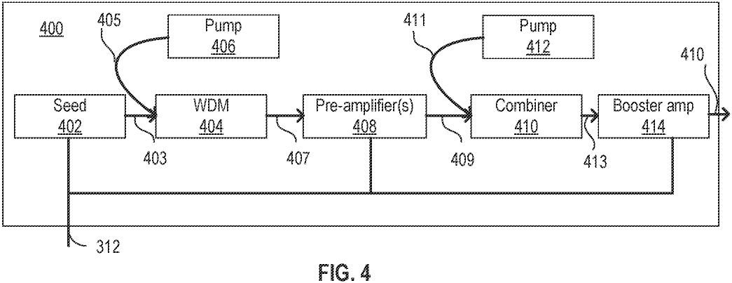

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The outputted light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector’s capability of maintaining linear relationship between input optical signal power and the detector’s output. A detector having good linearity can maintain a linear relationship over a large dynamic input optical signal range.

To achieve desired detector characteristics, configurations or customizations can be made to the light detector’s structure and/or the detector’s material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector’s internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and /or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LIDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

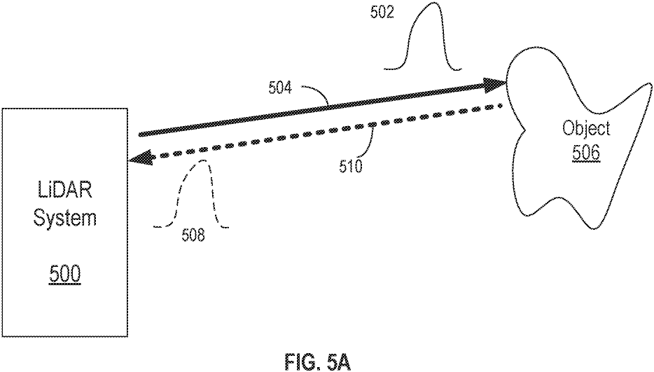

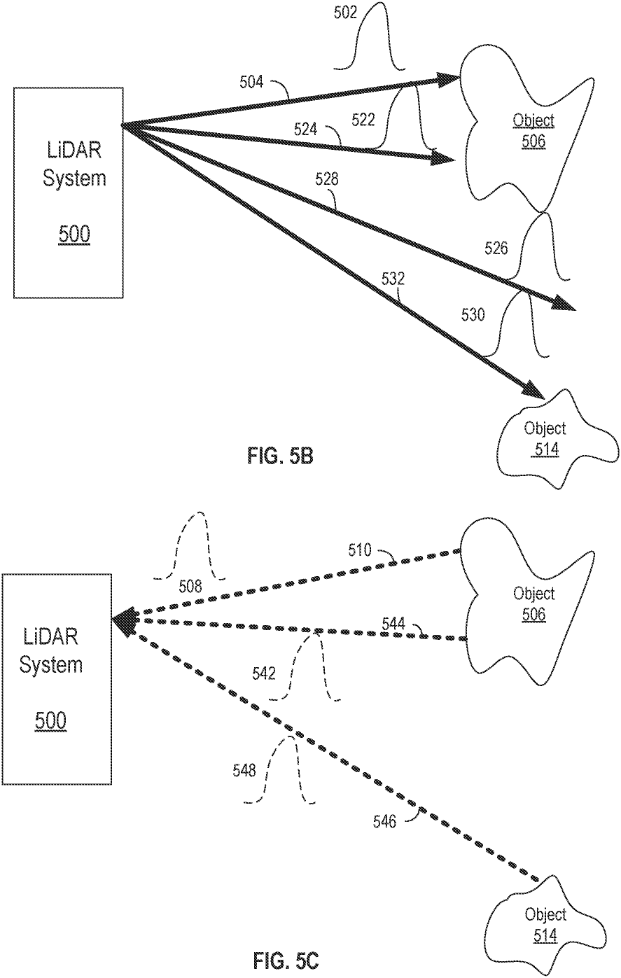

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

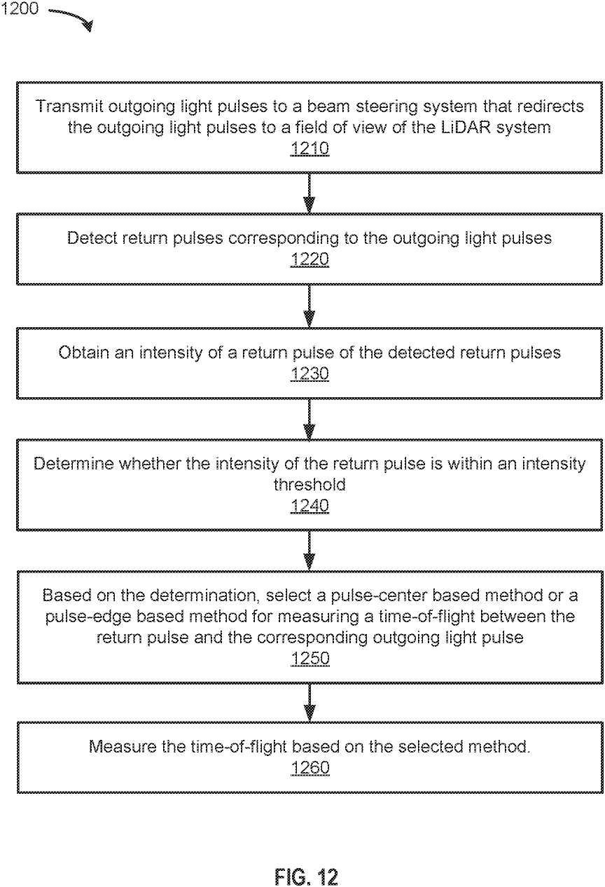

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of FIG. 12, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

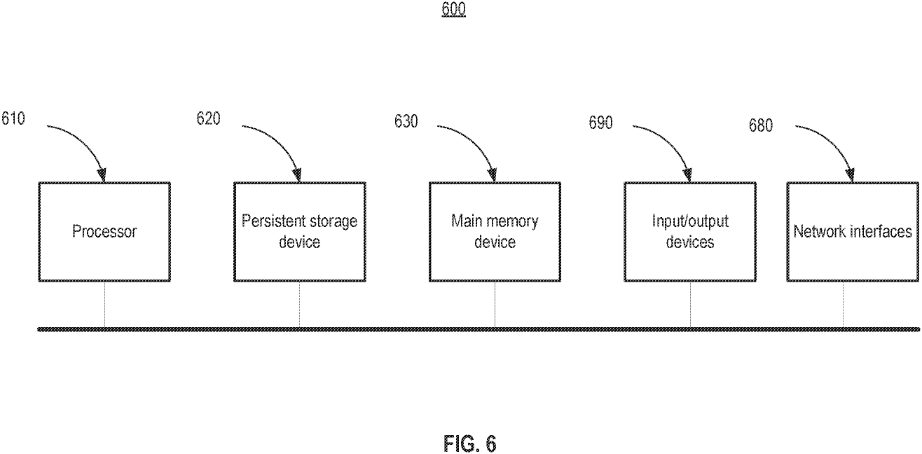

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of FIG. 12 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with FIG. 12. Accordingly, by executing the computer program instructions, the processor 610 executes an algorithm defined by the method steps of FIG. 12. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

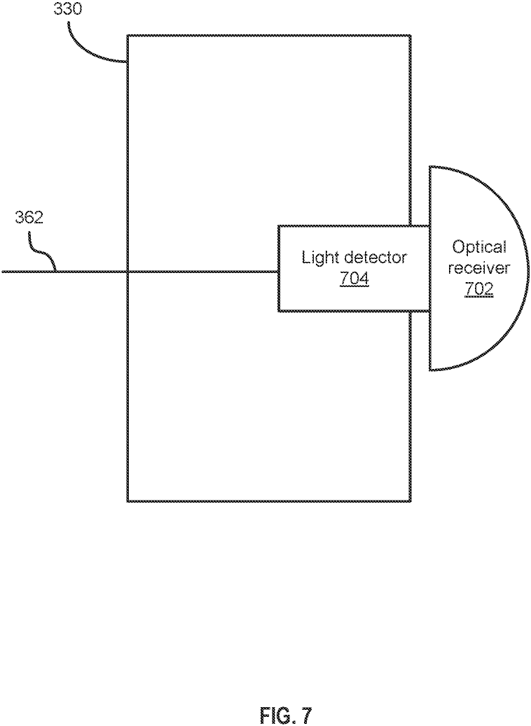

FIG. 7 is a block diagram illustrating an exemplary arrangement of components in optical receiver and light detector 330 of LiDAR system 300 according to an embodiment. Optical receiver and light detector 330 includes optical receiver 702 and light detector 704. Optical receiver 702 is configured to collect return light from the FOV and can include one or more optical lenses, lens groups, mirrors, prims, or the like to receive, focus, and direct the returned light. Light detector 704 detects the return light received by optical receiver 702 and generates current and/or voltage signals proportional to the incident intensity of the return light. Light detector 704 can be a charge coupled device (CCD), a photodiode, an avalanche photodiode (APD), a photomultiplier vacuum tube, or an image sensor, etc. Light detector 704 can also include filters to selectively pass light of certain wavelengths. Light detector 704 can transmit signals via communication path 362 to control circuitry 350 (shown in FIG. 3) indicating when returned light pulses are detected. Other data related to the return light pulses, such as amplitude, power, pulse shape, and wavelength, etc., of the return light pulses may also be transmitted via communication path 362 to control circuitry 350.

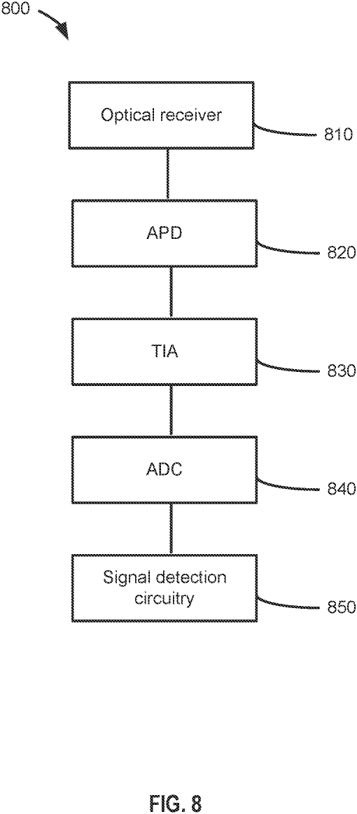

FIG. 8 is a block diagram illustrating an example return pulse detection system 800 according to an embodiment. System 800 can include an optical receiver 810, an avalanche photodiode (APD) 820, a transimpedance amplifier (TIA) 830, an analog-to-digital converter (ADC) 840, and a signal detection circuitry 850. Alternatively or additionally, system 800 may include a time-to-digital converter (TDC) instead of an ADC. System 800 can be a part of optical receiver and light detector 330 and/or control circuitry 350 as illustrated in FIGS. 3 and 7. Optical receiver 810 can be the same as optical receiver 702 in FIG. 7. APD 820, TIA 830, ADC 840, and signal detection circuitry 850 can be a part of light detector 704 in FIG. 7. In some embodiments, signal detection circuitry 840 may be a part of control circuitry 350.

Optical receiver 810 can include one or more optical lenses, lens groups, mirrors, prisms, etc. to receive, focus, and direct the return light pulses to APD 820. APD 820 operates based on the principle of avalanche multiplication and is configured to convert light pulses into electrical signals such as electrical current signals. TIA 830 converts an electrical current signal generated by APD 820 into a voltage signal, and amplifies the voltage signal to a level suitable for further processing. ADC 840 converts the voltage signal from an analog signal to a digital signal. The digital voltage signal is processed by signal detection circuitry 850 to determine the timing of the return light pulse.

Referring back to FIGS. 5A-5C, LiDAR system 500 determines the distance to objects 506 and 514 by measuring the time-of-flight of a light pulse from the time when a light pulse leaves LiDAR system 500 (e.g., outgoing light pulses 502, 522, and 530) to the time when the light pulse scattered from the object (e.g., return light pulses 508, 542, and 548) arrives back at LiDAR system 500. Distance to objects 506 and 514 can be determined by multiplying the time-of-flight and the speed of light. As the speed of light is approximately 30 kilometers per second, the distance that light can travel in one nanosecond is approximately 0.3 meters. Since time-of-flight is a measurement of a light pulse’s roundtrip travel time, a miscalculation of one nanosecond of time-of-flight can result in an error of approximately 0.15 meters in distance measurement. Therefore, the ability to accurately calculate time-of-flight plays an important role for LiDAR system 500 to determine the distance to an object.

With reference still to FIG. 8, the output of TIA 830 can be a continuous-time and continuous-amplitude analog voltage signal which resembles the waveform of the return light pulses 508, 542, and 548 in FIG. 5C. In one embodiment, ADC 840 samples the analog voltage signal from TIA 830 at a fixed sampling rate, e.g., at a sampling rate of 1 nanosecond, which is equivalent to a sampling frequency of 1 GHz, and assigns a discrete value to each sample. Each discrete value represents the amplitude of the analog voltage signal of the return light pulse at each sampling time. This process results in a discrete-time digital pulse signal that approximates the original continuous-time analog signal of the return light pulse.

As described above, an ADC has a dynamic range. The dynamic range of an ADC (Analog-to-Digital Converter) is the difference between the smallest and largest possible input voltage that can be accurately measured and digitized by the ADC. It is usually expressed in decibels (dB) and represents the ratio of the full-scale input voltage range to the noise floor of the ADC. The dynamic range of an ADC is determined by several factors, including the number of bits in the digital output, the signal-to-noise ratio (SNR), and the distortion and linearity of the ADC. The higher the number of bits in the digital output, the greater the resolution of the ADC and the smaller the quantization error. A higher SNR means that the ADC is better able to distinguish between the desired signal and any noise or interference present in the input signal.

If the input signal to ADC 840 exceeds a dynamic range of ADC 840, ADC 840 can only generate digital samples at the maximum of its dynamic range, resulting in signal saturation. Signal saturation may also happen when the input signal to ADC 840 is already saturated (e.g., output signal of APD 820 and/or TIA 830 is saturated). Nonetheless, when signal saturation occurs, the output digital signal of ADC 840 is clipped at a maximum value determined by the ADC dynamic range. Saturation at the output of ADC 840 can be caused by return light pulses having too high intensity, e.g., exceeding an intensity threshold. For example, if objects 506 or 514 in FIG. 5C are objects with high reflectivity, such as license plates, windows, or mirrors, etc. or if the objects are themselves light-generating objects, such as traffic lights or street lights, etc., the return light pulses from these objects tend to have high intensity and may cause ADC 840 to be saturated. When ADC 840 is saturated, the saturated digital output from ADC 840 may not accurately represent the entire waveform of the return light pulse. However, the timing of the saturated digital output can still be measured to determine the timing of the return light pulse, so that the time-of-flight of the light pulse can be calculated.

In some embodiments, to improve accuracy of measuring the TOF, the timing of a return light pulse can be measured differently depending on whether the return light pulse may result in ADC saturation. Two example measurement methods, pulse-center based method and pulse-edge based method, may be used for measuring the return pulse timing. Depending on whether the ADC is saturated, one of the two methods may be selected by the LiDAR system to measure the timing of the return light pulse. Also as explained previously, ADC saturation is likely to occur when the intensity of a return light pulse is high. Therefore, the determination of which one of the two measurement methods to use can be based on the calculation of the intensity of the return light pulses.

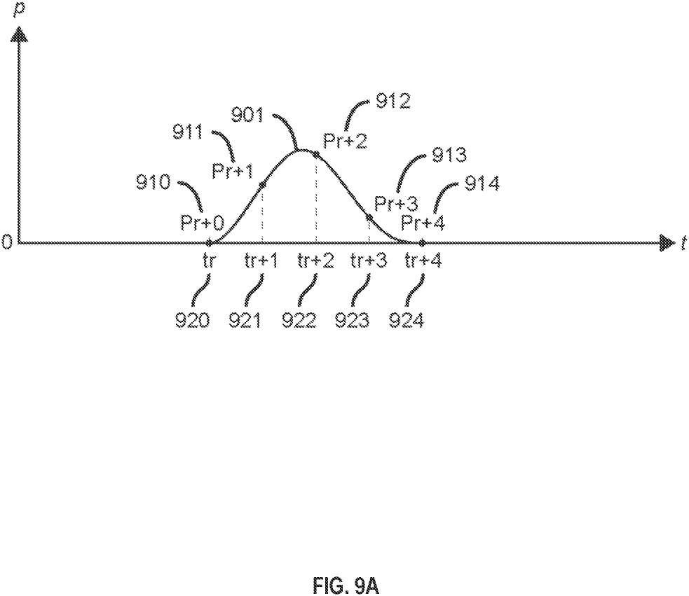

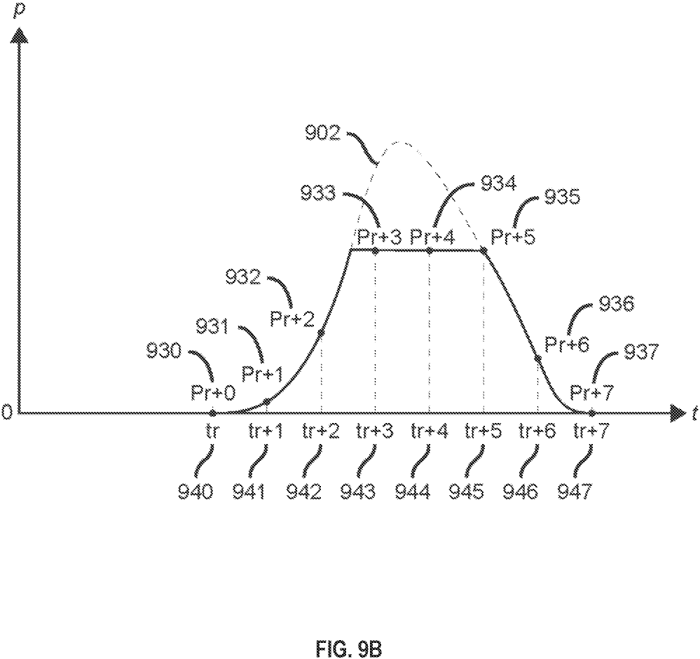

FIG. 9A illustrates an example return light pulse being sampled by ADC 840 when the ADC is not saturated. In FIG. 9A, the t-axis (horizontal axis) is the time axis representing the lapse of time. The origin of the t-axis is the start time when light source 310 generates an outgoing light pulse. In some embodiments, this start time is equivalent to the time when the outgoing light pulse leaves the LiDAR system. Waveform 901 is the analog waveform of the return light pulse measured at the output of TIA 830. The p-axis (vertical axis) represents the voltage amplitude of the waveform. Waveform 901 is sampled by ADC 840 at a sampling rate of, e.g., 1 nanosecond, and is sampled at times 920 (tᵣ), 921 (tᵣ₊₁), 922 (tᵣ₊₂), 923 (tᵣ₊₃), and 924 (tᵣ₊₄). The corresponding voltage amplitudes of return light pulse 901 at each sampled time are amplitudes 910 (Pᵣ₊₀), 911 (Pᵣ₊₁), 912 (Pᵣ₊₂), 913 (Pᵣ₊₃), and 914 (Pᵣ₊₄), respectively. In this example, because the amplitude of waveform 901 does not exceed the dynamic range of ADC 840, ADC 840 is not saturated. The series of the sampled digital values of 910-914 (imagining connecting 910-914 with line segments) may sufficiently represent the shape of the analog waveform 901. It is understood that while FIG. 9A uses 1 nanosecond sampling rate as an example, other sampling rates are also possible.

FIG. 9B illustrates an example return light pulse being sampled by ADC 840 when the ADC is saturated at a maximum output value. Similar to FIG. 9A, in FIG. 9B, the t-axis is the time axis representing the lapse of time. The origin of the t-axis is the start time when light source 310 generates an outgoing light pulse. In some embodiments, this start time is equivalent to the time when the outgoing light pulse leaves the LiDAR system. Waveform 902 (including the dashed portion of the waveform on top but not the flat, truncated portion) represents the analog waveform of the return light pulse measured at the output of TIA 830 before it is sampled by ADC 840. The p-axis represents voltage amplitude of the waveform.

Waveform 902 is sampled by ADC 840 at a sampling rate of, e.g., 1 nanosecond, and is sampled at times 940 (tᵣ), 941 (tᵣ₊₁), 942 (tᵣ₊₂), 943 (tᵣ₊₃), 944 (tᵣ₊₄), 945 (tᵣ₊₅), 946 (tᵣ₊₆), and 947 (tᵣ₊₇). Because the amplitude of a portion of waveform 902 (e.g., the dashed line portion) exceeds the dynamic range of ADC 840, the output of ADC 840 is truncated at a maximum output value determined by the dynamic range of ADC 840. The corresponding voltage amplitudes of waveform 902 at each sampled time are amplitudes 930 (Pᵣ₊₀), 931 (Pᵣ₊₁), 932 (Pᵣ₊₂), 933 (Pᵣ₊₃), 934 (Pᵣ₊₄), 935 (Pᵣ₊₅), 936 (Pᵣ₊₆), and 937 (Pᵣ₊₇), respectively. As shown in FIG. 9B, amplitudes 933 (Pᵣ₊₃), 934 (Pᵣ₊₄), and 935 (Pᵣ₊₅) are saturated and clipped at the maximum output value. Because of the saturation, the series of the sampled digital values of 930-937 (imagining connecting 930-937 with line segments) have a truncated, flat top and do not sufficiently represent the shape of the analog waveform 902.

It should be appreciated that ADC 840 being saturated at the maximum output value determined by its dynamic range as shown in FIG. 9B is merely illustrative. The maximum amplitude at which ADC 840 may be saturated may vary depending on the types of ADC and/or the settings of the ADC, such as the bit depth, input impedance or gain settings, etc., of the ADC.

After the digital waveform of a return light pulse is provided by ADC 840 (whether saturated or not), signal detection circuitry 850 then uses the sampled digital waveform to determine the timing of the return light pulse. As explained previously, two exemplary methods, pulse-center method and pulse-edge method, are being used to determine the timing (delay) of the return light pulse. Depending on whether the calculated intensity of the return light pulse is above or below an intensity threshold, signal detection circuitry 850 can use one of the two methods to measure the timing of the return light pulse.

The intensity of a digital waveform is the sum of the sampled amplitude value of the waveform at each sampled position. Therefore, the intensity of the waveforms in FIGS. 9A and 9B can be calculated using the following formula (1):

$$I n t e n s i t y = {\sum }_{i = 0}^{n} P r + i \qquad \text{(1)}$$

In the above formula (1), r + i represents each sampled position, Pᵣ₊ᵢ represents the amplitude of the waveform at sampled position r+i, and n represents the last sampled position of the waveform. For example, in FIG. 9A, n is 4, representing that the last sampled position of return light pulse 901 is r+4 (position 924) and the amplitude of that sampled position is Pᵣ₊₄ (amplitude 914).

Using formula (1), the intensity of return light pulse 901 in FIG. 9A can be calculated as the sum of Pᵣ₊₁ + Pᵣ₊₂ + Pᵣ₊₃ (since the value of Pᵣ₊₀ and Pᵣ₊₀ is zero or negligible). The intensity of return light pulse 902 in FIG. 9B can be calculated as the sum of Pᵣ₊₁ + Pᵣ₊₂ + Pᵣ₊₃ + Pᵣ₊₄ + Pᵣ₊₅ + Pᵣ₊₆ (since the value of Pᵣ₊₀ and Pᵣ₊₇ is zero or negligible).

After the intensity of the return light pulse is obtained, signal detection circuitry 850 determines if the intensity is within an intensity threshold. In some embodiments, intensity threshold can be a percentage of a maximum intensity range of a return light pulse. For example, the intensity threshold can be about 5%, 20%, 55%, or 80%, etc., of the maximum intensity range. In one embodiment, the intensity threshold can be at about 8%. In other embodiments, intensity threshold can be a positive number indicating an intensity level. In one embodiment, the intensity threshold can be at about 6,000.

If the intensity of a return light pulse is within the intensity threshold, the signal is likely not saturated, and the output from ADC 840 may thus sufficiently represent the shape of the return light pulse. In this situation, a “center” of the pulse may generate a more accurate representation of the timing of the return light pulse. Thus, when the intensity of the return light pulse is within the intensity threshold, signal detection circuitry 850 selects the pulse-center based method (described in greater details below) to determine the timing of the return light pulse.

If the intensity of the return light pulse exceeds the intensity threshold, the signal may be saturated at the output of ADC 840. The top of the signal waveform is flat and truncated. As a result, the output from ADC 840 cannot sufficiently represent the entire shape of the return light pulse. In this situation, using the pulse-center based method may generate significant errors because the pulse-center calculation requires data points sufficiently representing the overall shape of the pulse. Thus, when the intensity of the return light pulse exceeds the intensity threshold, signal detection circuitry 850 selects an alternative, pulse-edge based method (more discussions below) to determine the timing of the return light pulse.

In other embodiments, the selection process above may be reversed. If the intensity of a return light pulse exceeds the intensity threshold, signal detection circuitry 850 selects the pulse-center based method to determine the timing of the return light pulse. If the intensity is within an intensity threshold, the pulse-edge based method is selected. In some embodiments, both pulse-center based method and pulse-edge based method may be selected to, for example, cross-check the accuracy of measuring the TOF.

A pulse-center based method posits that the timing of the return light pulse happens at the “center” of the waveform. There are various ways to use a pulse-center based method to find a “center” of a waveform, such as finding the arithmetic mean, the median, the geometric center, the center of gravity, or the peak value, etc., of the waveform. The center of gravity (also called “weighted mean”, or “weighted center”) method of finding a center of a waveform is calculated by taking the weighted average of the waveform’s x and y coordinates. The weighted mean method calculates the sum of the product of each x coordinate and its corresponding y coordinate, divided by the sum of the y coordinates. The weighted mean of a waveform provides a better representation of the central tendency of the waveform.

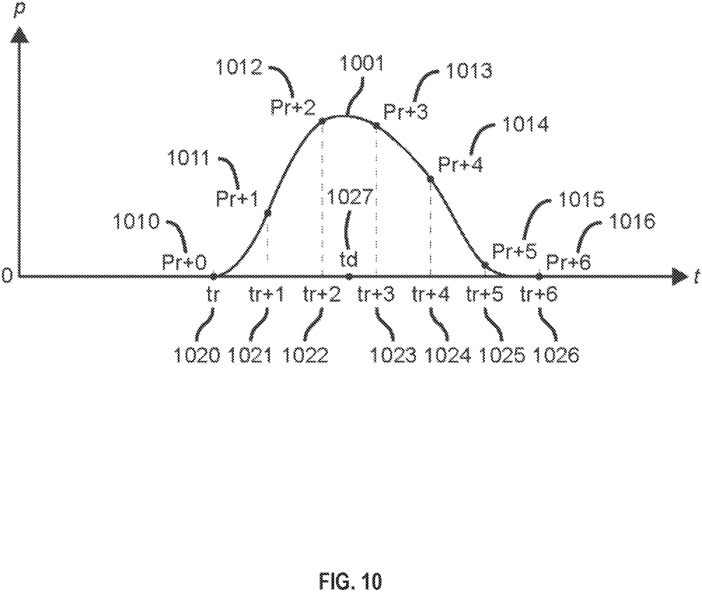

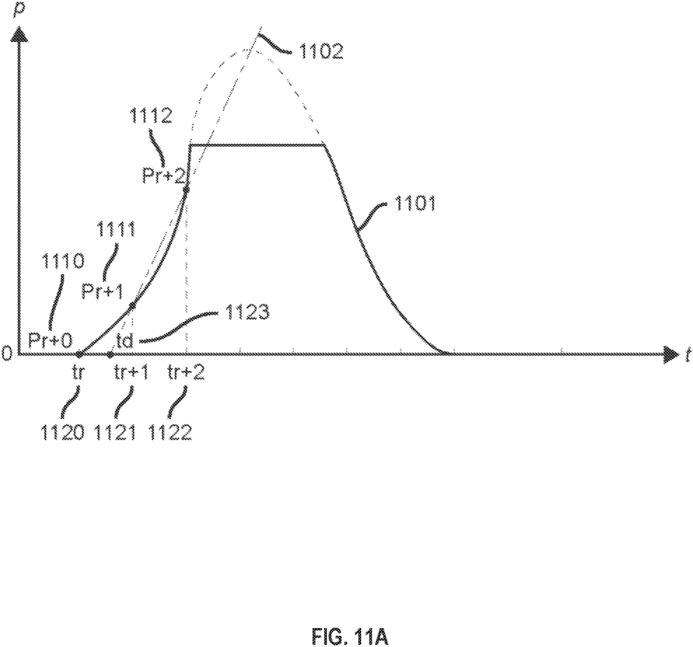

FIG. 10 illustrates using a pulse-center based method to find the timing of a return light pulse. Similar to FIGS. 8 and 9, in FIG. 10, the t-axis is the time axis representing the lapse of time. The origin of the t-axis is the start time when light source 310 generates an outgoing light pulse. In some embodiments, this start time is equivalent to the time when the outgoing light pulse leaves the LiDAR system. Waveform 1001 is the analog waveform of the return light pulse measured at the output of TIA 830. The p-axis represents voltage amplitude of the waveform. Waveform 1001 is sampled by ADC 840 at a sampling rate of, e.g., 1 nanosecond, and is sampled at times 1020 (tr), 1021 (tᵣ₊₁), 1022 (tᵣ₊₂), 1023 (tᵣ₊₃), 1024 (tᵣ₊₄), 1025 (tᵣ₊₅), and 1026 (tᵣ₊₆). The corresponding voltage amplitudes of return light pulse 1001 at each sampled time are amplitudes 1010 (Pᵣ₊₀), 1011 (Pᵣ₊₁), 1012 (Pᵣ₊₂), 1013 (Pᵣ₊₃), 1014 (Pᵣ₊₄), 1015 (Pᵣ₊₅), and 1016 (Pᵣ₊₆), respectively.

The weighted mean of waveform 1001 can be calculated using the following formula (2):

$$W e i g h t e d m e a n \left(t d\right) = \frac{{\sum }_{i = 0}^{n} \left(P r + i \times t r + i\right)}{{\sum }_{i = 0}^{n} Pr + \text{i}} \qquad \text{(2)}$$

In the above formula (2), tᵣ₊ᵢ represents each sampled position, Pᵣ₊ᵢ represents the amplitude of the waveform at sampled position tᵣ₊ᵢ, and n represents the last sampled position of the waveform. For example, in FIG. 10, n is 6, representing that the last sampled position of return light pulse 1001 is tᵣ₊₆ (position 1026) and the amplitude of that sampled position is Pᵣ₊₆ (amplitude 1016).

Based on formula (2), the weighted mean of waveform 1001 may be calculated to be at time t_{d} (time 1027) as shown in FIG. 10. The time-of-flight of this particular light pulse can therefore be calculated using t_{d} because it represents the travel time from when the outgoing pulse is generated (at time 0) to the time when the return light pulse is received at the LiDAR system (at time t_{d}).

A pulse-edge based method posits that the timing of the return light pulse happens at an edge of the waveform such as the rising edge. The rising edge of a waveform refers to the transition of the waveform from a low level to a high level. There are various ways to detect a rising edge of a waveform. Some of the edge-detecting methods are, e.g., threshold detection method, differentiation method, zero-crossing method, or edge-triggered detection method, etc. For example, threshold detection method detects rising edges in a waveform by comparing the signal voltage with a threshold value. When the signal voltage level exceeds the threshold value, a rising edge is detected. However, this method may not be suitable when substantial noise is present in the received signals, as the noise may lead to false detections.

In return pulse detection system 800, the rising edge of the return light pulse is sampled by ADC 840. Depending on the sampling rate of ADC 840, the rising edge of the return light pulse may be sampled one or multiple times. For example, in FIG. 9B, the rising edge of waveform 902 is sampled two times at tᵣ₊₁ (time 941) and at tᵣ₊₂ (time 942). Using the pulse-edge based method described below, the rising edge of waveform 902 may happen at neither time 941 nor 942, but at a time more approximate to the time when the waveform’s rising edge starts to rise. It should be appreciated that although the pulse-edge method described herein detects the rising edge of a return light pulse, the method can also be used for detecting the falling edge of a return light pulse.

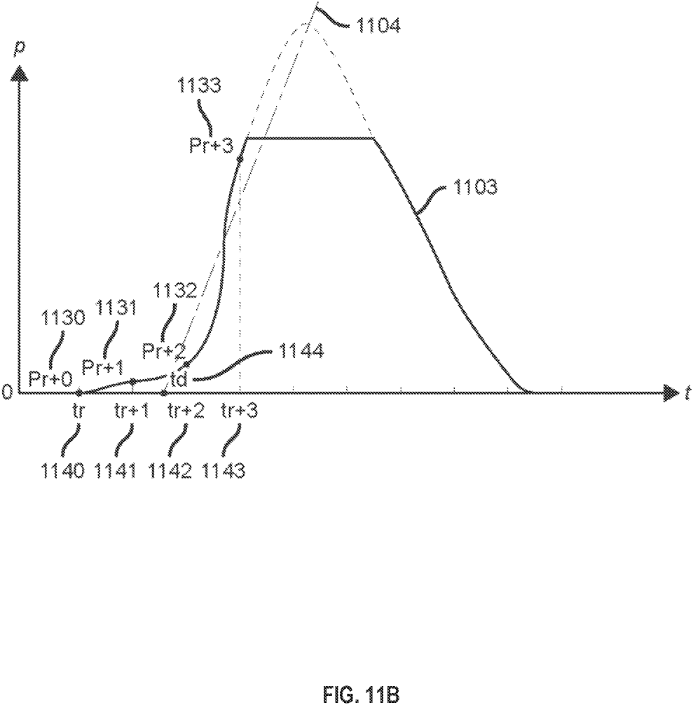

FIG. 11A illustrates a pulse-edge method used to find the timing of a return light pulse when there are two sampled points on the rising edge according to an embodiment. Similar to the previous figures, in FIG. 11, the t-axis is the time axis representing the lapse of time. The origin of the t-axis is the start time when light source 310 generates an outgoing light pulse. In some embodiments, this start time is equivalent to the time when the outgoing light pulse leaves the LiDAR system. Waveform 1101 is similar to waveform 902 of FIG. 9B, except that only the sampled points for the rising edge of the waveform are shown. The p-axis represents voltage amplitude of the waveform. The rising edge of waveform 1101 is sampled by ADC 840 at a sampling rate of, e.g., 1 nanosecond, and is sampled at times 1120 (tᵣ), 1121 (tᵣ₊₁), and 1122 (tᵣ₊₂). The corresponding voltage amplitudes of return light pulse 1101 at each sampled time are amplitudes 1110 (Pᵣ₊₀), 1111 (Pᵣ₊₁), and 1112 (Pᵣ₊₂), respectively.

Since the sampled value at time 1120 (Pᵣ₊₀) is zero, the rising edge of waveform 1101 is being sampled twice by ADC 840, which are at times 1121 (tᵣ₊₁) and 1122 (tᵣ₊₂). When there are two sampled points of a rising edge, the timing of the rising edge (hence the timing of waveform 1101) can be calculated by finding the t-intercept t_{d} (1123), which is the intersection of line 1102 and the t-axis, where line 1102 is a straight line drawn from point 1111 (Pᵣ₊₁) to point 1112 (Pᵣ₊₂).

When the rising edge has two sampled points, t_{d} (1123) can be calculated using the following formula (3):

$$t d = \frac{\text{tr+1} \times \text{Pr+2} - t r + 2 \times P r + 1}{\text{Pr+2} - \text{Pr+1}} \qquad \text{(3)}$$

In formula (3), tᵣ₊₁ represents the first sampled position of the rising edge, Pᵣ₊₁ represents the amplitude of the waveform at the first sampled position tᵣ₊₁, tᵣ₊₂ represents the second sampled position of the rising edge, and Pᵣ₊₂ represents the amplitude of the waveform at the second sampled position tᵣ₊₂. Based on this calculation, t_{d} can approximate the time when waveform 1101′s rising edge starts to rise.

FIG. 11B illustrates another pulse-edge method used to find the timing of a return light pulse when there are more than two sampled points on the rising edge according to an embodiment. The t-axis is the time axis representing the lapse of time. The origin of the t-axis is the start time when light source 310 generates an outgoing light pulse. In some embodiments, this start time is equivalent to the time when the outgoing light pulse leaves the LiDAR system. Waveform 1103 is similar to waveform 902 of FIG. 9B, except that only sampled points for the rising edge of the waveform are shown. The p-axis represents voltage amplitude of the waveform. The rising edge of waveform 1103 is sampled by ADC 840 at a sampling rate of, e.g., 1 nanosecond, and is sampled at times 1140 (tᵣ), 1141 (tᵣ₊₁), 1142 (tᵣ₊₂), and 1143 (tᵣ₊₃). The corresponding voltage amplitudes of return light pulse 1103 at each sampled time are amplitudes 1130 (Pᵣ₊₀), 1131 (Pᵣ₊₁), 1132 (Pᵣ₊₂), and 1133 (Pᵣ₊₃), respectively.

Since the sampled value at time 1140 (Pᵣ₊₀) is zero, the rising edge of waveform 1103 is being sampled three times by ADC 840, which are at times 1141 (tᵣ₊₁), 1142 (tᵣ₊₂), and 1143 (tᵣ₊₃). When there are more than two sampled points on a signal’s rising edge, different calculation methods may be used to find t_{d}. For example, a straight line can be drawn between any of the two sampled points, e.g., from point 1131 (Pᵣ₊₁) to point 1132 (Pᵣ₊₂), from point 1131 (Pᵣ₊₁) to point 1133 (Pᵣ₊₃), or from point 1132 (Pᵣ₊₂) to point 1133 (Pᵣ₊₃), so that formula (3) can be used to find t_{d}, which is the t-intercept of a drawn line and the t-axis.

Alternatively, a least squares regression line may be calculated and used to find t_{d}, which is the t-intercept of the least squares regression line and the t-axis. The least squares regression line is a method used to find a line that best fits a group of sampled data points. In a t-p coordinate as depicted in FIG. 11B, line 1104 is the least squares regression line of the three sampled points on the rising edge. The line function of line 1104 is denoted as p = a + bt, where a is the p-intercept (the value of p when t = 0), and b is the slope of the line. The t-intercept t_{d} (1144) of line 1104 can be calculated using the following formula (4):

$$t d = - \frac{a}{b} \qquad \text{(4)}$$

where

$$b = \frac{\sum \left(t - \overline{t}\right) \left(p - \overline{p}\right)}{\sum {\left(t - \overline{t}\right)}^{2}} ,$$

in which t̅ is the means of time value of the sampled points, such as tᵣ₊₁, tᵣ₊₂, and tᵣ₊₃, and p̅ is the means of the corresponding amplitude values, such as point 1131 (Pᵣ₊₁), point 1132 (Pᵣ₊₂), and point 1133 (Pᵣ₊₅), and where

$$a = \frac{\sum p - b \sum t}{n} ,$$

in which t and p are the time and amplitude values of each sampled points, and n is the number of the sampled points. For example, in FIG. 11B, n is 3 since the number of sampled points on the rising edge is 3.

It should be appreciated that the method described herein may be used in situations where the rising edge is sampled three or more times. Although FIG. 11B only shows three sampled points on the waveform’s rising edge, the method can be used when the rising edge is sampled for more than three times, e.g., four or five times, or more.

When the rising edge of a return signal is sampled only one time, various different methods may be used to find the timing of the rising edge. For example, the timing could be simply the sampled time of the rising edge. The timing could also be the one previous sampled time before the rising edge is sampled, or the middle between the two sampled points. In addition, different filters may be used to recover the slope of the rising edge, hence more sampled points may be assigned to the slope, so that formulas (2) or (3) may be used.

FIG. 12 is a flowchart illustrating a method for calculating time-of-flight on a LiDAR system. In some embodiments, method 1200 may be performed by LiDAR system 300 in FIG. 3, optical receiver and light detector 330 in FIGS. 3 and 7, control circuitry 350 in FIG. 3, and/or signal detection circuitry 850 in FIG. 8. Method 1200 includes step 1210, in which a LiDAR system transmits outgoing light pulses to a beam steering system that redirects the outgoing light pulses to a field of view of the LiDAR system. Referring back to FIG. 3, LiDAR system 300 transmits outgoing light pulses generated by light source 310 via transmitter 320 and steering mechanism 340 to the field of view. The starting point of the time-of-flight calculation is the time when the outgoing light pulse is generated, or when the outgoing light pulse leaves the LiDAR system. Method 1200 further includes step 1220, in which the LiDAR system detects return pulses corresponding to the outgoing light pulses. The return pulse is being detected by optical receiver and light detector 330, control circuitry 350, and/or signal detection circuitry 850.

In some embodiments, method 1200 further includes step 1230-1260, which are performed by optical receiver and light detector 330, control circuitry 350, and/or signal detection circuitry 850. At step 1230, control circuitry 350 obtains an intensity of the return pulse of the detected return pulses. The intensity of the return pulse is calculated using formula (1) described above. At step 1240, control circuitry 350 determines whether the intensity of the return pulse is within an intensity threshold. In some embodiments, intensity threshold can be a percentage of a maximum intensity range of a return pulse. In other embodiments, intensity threshold can be a positive number indicating an intensity level. At step 1250, based on the determination, control circuitry 350 selects either a pulse-center based method or a pulse-edge based method for measuring a time-of-flight between the return pulse and the corresponding outgoing light pulse. In some embodiments, if the intensity of the return light pulse is within the intensity threshold, control circuitry 350 selects the pulse-center based method to find the timing of the return light pulse. If the intensity exceeds the intensity threshold, the pulse-edge based method will be used. In other embodiments, if the intensity of the return light pulse exceeds the intensity threshold, control circuitry 350 uses the pulse-center based method to find the timing of the return light pulse. If the intensity is within an intensity threshold, the pulse-edge based method will be used.

At step 1260, control circuitry 350 measures the time-of-flight based on the method selected in step 1250. If a pulse-center based method is selected, control circuitry 350 uses one of the pulse-center methods to determine the timing of the return pulse. For example, a weighted mean method may be used to calculate the timing using formula (2). If a pulse-edge based method is selected, control circuitry 350 uses one of the pulse-edge methods to determine the timing of the return pulse. For example, formulas (3) or (4) may be used to calculate the timing of the return pulse. After the timing of the return pulse is calculated, time-of-flight is measured as the travel time from when the outgoing pulse leaves the LiDAR system to the timing of the return pulse just calculated.

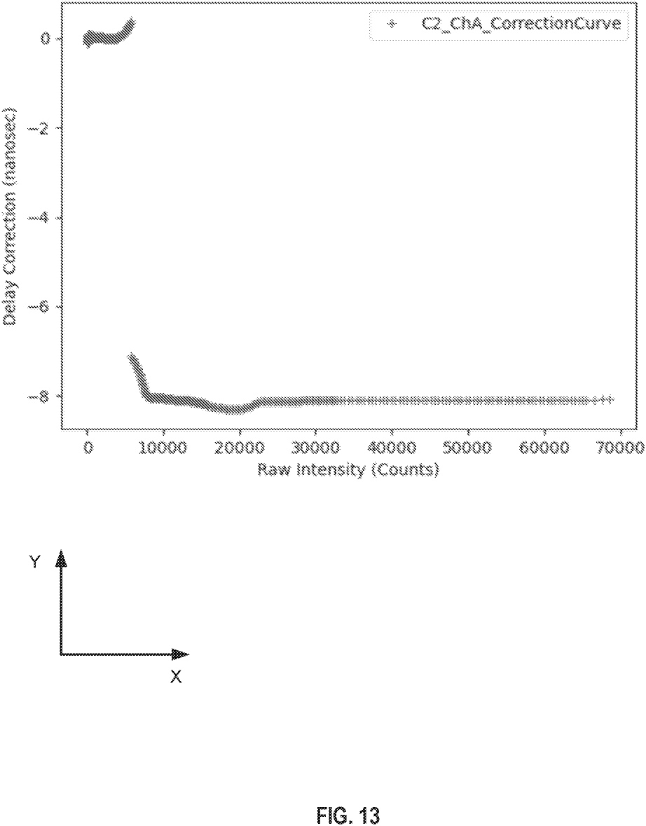

When measuring the time-of-flight using the pulse-edge method, measurement errors may occur. The reasons for errors may be because the return pulses are too wide, or may contain substantial noises, etc. To compensate for these errors, a delay correction may be applied to the measured time-of-flight. Based on the correlation between the delay correction and the intensity of the return pulse, an Intensity To Distance Correction Table may be implemented. FIG. 13 illustrates an intensity to distance correction curve according to one embodiment. The x coordinate depicts the raw intensity of return pulses received by the LiDAR system. The y coordinate depicts the delay correction in nanoseconds corresponding to the intensity of the return pulses.

As shown in FIG. 13, the maximum intensity level of return light pulses is at about 70,000. When the intensity of the return light pulses is below an intensity threshold, e.g., at approximately 6,000, or about 8% of the maximum intensity range, the correction curve is close to zero. As explained previously, according to one embodiment, when the intensity is at this range, a pulse-center method is used to calculate the timing of the return light pulse. When the intensity of the return light pulses is between approximately 6,000 and 30,000, or between about 8% to 43% of the maximum intensity range, the correction curve varies. When the intensity of the return light pulses is beyond approximately 30,000, or about 43% of the maximum intensity range, the correction curve stabilizes at around -8 ns. As explained previously, according to one embodiment, when the intensity is at a range beyond the intensity threshold, a pulse-edge method is used to calculate the timing of the return light pulse. Based on the correlation between the correction value and the intensity of the return light pulse, the Intensity To Distance Correction Table may be constructed, and the correction value corresponding to each intensity level can be applied to offset the measured time-of-flight in order to achieve a more accurate time-of-flight calculation.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A light detection and ranging (LiDAR) system, comprising:
a beam steering system;
a light source configured_to emit outgoing light pulses that are steered by the beam steering system in accordance with a field of view of the LiDAR system;
a detection system configured to detect return pulses corresponding to the outgoing light pulses; and
a controller comprising one or more processors, a memory device, and processor-executable instructions stored in the memory device, the processor-executable instructions comprising instructions for:
obtaining an intensity of a return pulse of the detected return pulses,
determining whether the intensity of the return pulse is within an intensity threshold,
based on the determination, selecting a pulse-center based method or a pulse-edge based method for measuring a time-of-flight between the return pulse and the corresponding outgoing light pulse, the time-of-flight being a time lapse between a timing of the return pulse and a timing of the corresponding outgoing light pulse, and
measuring the time-of-flight based on the selected method.

2. The LiDAR system of claim 1, wherein selecting the pulse-center based method is based on the determination that the intensity of the return pulse is within the intensity threshold, and wherein selecting the pulse-edge based method is based on the determination that the intensity of the return pulse is not within the intensity threshold.

3. The LiDAR system of claim 1, wherein selecting the pulse-center based method is based on the determination that the intensity of the return pulse is not within the intensity threshold, and wherein selecting the pulse-edge based method is based on the determination that the intensity of the return pulse is within the intensity threshold.

4. The LiDAR system of claim 1, wherein the timing of the return pulse determined using the pulse-center based method is determined by finding a weighted mean of the return pulse.

5. The LiDAR system of claim 1, wherein the timing of the return pulse determined using the pulse-edge based method is determined by finding a timing of an edge of the return pulse.

6. The LiDAR system of claim 1, wherein the processor-executable instructions comprise further instructions for:
adjusting the measured time-of-flight using an intensity to distance correction table.

7. The LiDAR system of claim 6, wherein the intensity to distance correction table comprises parameters to be adjusted when the pulse-edge based method is selected.

8. The LiDAR system of claim 1, wherein the intensity threshold is about 8%.

9. The LiDAR system of claim 1, wherein the detection system comprises:
at least one receiving lens;
a detector comprising an avalanche photo diode (APD) detector; and
an analog-to-digital converter (ADC).

10. A method for using a light detection and ranging (LiDAR) system, comprising:
transmitting outgoing light pulses to a beam steering system that redirects the outgoing light pulses to a field of view of the LiDAR system;
detecting return pulses corresponding to the outgoing light pulses;
obtaining an intensity of a return pulse of the detected return pulses;
determining whether the intensity of the return pulse is within an intensity threshold;
based on the determination, selecting a pulse-center based method or a pulse-edge based method for measuring a time-of-flight between the return pulse and the corresponding outgoing light pulse, the time-of-flight being a time lapse between a timing of the return pulse and a timing of the corresponding outgoing light pulse; and
measuring the time-of-flight based on the selected method.

11. The method of claim 10, wherein selecting the pulse-center based method is based on the determination that the intensity of the return pulse is within the intensity threshold, and wherein selecting the pulse-edge based method is based on the determination that the intensity of the return pulse is not within the intensity threshold.

12. The method of claim 10, wherein selecting the pulse-center based method is based on the determination that the intensity of the return pulse is not within the intensity threshold, and wherein selecting the pulse-edge based method is based on the determination that the intensity of the return pulse is within the intensity threshold.

13. The method of claim 10, wherein the timing of the return pulse determined using the pulse-center based method is determined by finding a weighted mean of the return pulse.

14. The method of claim 10, wherein the timing of the return pulse determined using the pulse-edge based method is determined by finding a timing of an edge of the return pulse.

15. The method of claim 10, further comprising:
adjusting the measured time-of-flight using an intensity to distance correction table.

16. The method of claim 15, wherein the intensity to distance correction table comprises parameters to be adjusted when the pulse-edge based method is selected.

17. The method of claim 10, wherein the intensity threshold is about 8%.
